(19) United States
(12) Patent Application Publication
(10) Pub. No.: US 2026/0259107 A1
(43) Pub. Date: Sep. 3, 2026

(54) A FIBRE OPTIC CABLE MONITORING METHOD AND SYSTEM

(71) Applicant: FIBER SENSE LIMITED, Mosman, NSW (AU)

(72) Inventors: Nathaniel LINDSEY, Oakland, CA (US); Mark Andrew ENGLUND, Sydney (AU)

(21) Appl. No.: 19/163,829

(22) PCT Filed: Mar. 8, 2024
(86) PCT No.: PCT/AU2024/050200

§ 371 Date: Sep. 9, 2025

Related U.S. Application Data
(60) Provisional application No. 63/451,511, filed on Mar. 10, 2023.

(51) Int. Cl. G01M 11/00; G01L 1/24; G01M 5/00

(52) U.S. Cl. CPC G01M 11/3145; G01L 1/242; G01M 5/0025; G01M 5/0091

(57) ABSTRACT

Method and system for determining the condition of a cable are disclosed. The method includes: transmitting interrogating signals into a sensing optical fibre extending the length of the cable and receiving backscattered signals from the sensing optical fibre in response to the interrogating signals. The method further includes processing the backscattered signals to determine variations in strain or strain rate along the sensing optical fibre and determining the time history of the strain or strain rate to obtain accumulated strain data indicative of the condition of the cable at points along the cable.

### TECHNICAL FIELD

Aspects of the present disclosure are generally directed to methods and/or systems for monitoring fibre optic cables and in particular are related to methods and/or associated systems for monitoring the condition of fibre optic cables.

### BACKGROUND

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

Cable assets such as power cables and telecommunication cables currently require to be robustly designed to withstand different types of external artificial and natural hazards (for example vessels, anchors, drag nets, excavators, enlarged marine animals, rockfall, currents, natural abrasion and corrosion, high pressure, extreme temperatures, undersea volcanos, tsunamis and earthquakes). Safety requirements to protect cables include using steel armor, plastic insulation, and gel as a way of protecting the cables from their surrounding damaging environments. For example, FIG. 1 shows a typical double armored submarine fibre optic cable 100. The fibre 102 is at the center, and it is protected from its surrounding environment by several core layers of polycarbonate or aluminum strands 106, steel strands 108, and plastic such as nylon 104, with an outer sheath of PE or the like. Such cables are also usually buried.

Generally, submarine optical cables are deployed and used until they fail or are depreciated over their specified lifetime of 20-25 years. During their lifetime, the optical cables experience tension and compression due to the presence of external hazards (e.g., earthquakes) that can cause permanent deformation of the cable, affecting the performance of the fibre.

### SUMMARY

According to a first aspect of the present disclosure there is provided a method for determining the condition of a cable. The method includes: transmitting interrogating signals into a sensing optical fibre extending the length of the cable and receiving backscattered signals from the sensing optical fibre in response to the interrogating signals. The method further includes processing the backscattered signals to determine variations in strain or strain rate along the sensing optical fibre and determining the time history of the strain or strain rate to obtain accumulated strain data indicative of the condition of the cable at points along the cable.

In an embodiment, the cable is: a submarine fibre optic cable having at least one primary fibre optic telecommunications or a sensing cable which doubles as the sensing optical fibre.

In an embodiment, the cable is a power cable and the sensing optical fibre is embedded inside the power cable or bundled in a nearby but separate cable.

In an embodiment, processing the backscattered signals includes determining the dynamic strain rate at adjoining locations along the length of the fibre to obtain dynamic strain rate data, and determining the time history of the strain rate include integrating the dynamic strain rate data over a predetermined period of time.

In an embodiment, the method further includes comparing the accumulated strain data against a threshold based on cable specification data and generating an alert condition in the event of the threshold being exceeded at at least one location along the cable.

In an embodiment, the method further includes determining cable risk, and generating an alert condition in the event of a high risk being identified and the threshold being exceeded.

In an embodiment, the risk is based on natural and/or man-made risks or hazards in the vicinity of the at least one location.

In an embodiment, distributed fibre optic sensing (DFOS) is used to detect at least one of Rayleigh, Brillouin, and Raman scattering in order to assess variations in strain or strain rate.

In an embodiment, the method further includes mapping the time history of strain or strain rate data along the length of the cable to provide visible indicia of the condition of the cable.

In an embodiment, the method further includes mapping the location of natural and/or manmade risks or hazards in the vicinity of the cable.

In an embodiment, determining the dynamic strain rate at adjoining locations along the length of the fibre to obtain dynamic strain rate data includes converting raw data from the backscattered signals to strain-rate equivalent units with the following formula: ε(x,t)=λ/4πngξ dφ(t), where λ is the optical wavelength, n is refractive index, g is the gauge length, defined as the distance between two points of the fibre where the measurement is taken, and ξ=0.7869.

According to a second aspect of the present disclosure there is provided a distributed fiber optic sensing (DFOS) system for determining the condition of a cable. The system includes: a light source for transmitting interrogating signals into a sensing optical fibre extending the length of the cable; a photodetector for receiving backscattered signals from the sensing optical fibre in response to the interrogating signals; and a processing unit configured to: process the backscattered signals to determine variations in strain or strain rate along the sensing optical fibre; and determine the time history of the strain or strain rate to obtain accumulated strain data indicative of the condition of the cable at points along the cable.

In an embodiment, the processing unit is further configured to: determine cable risk, and generate an alert condition in the event of a high risk being identified and the threshold being exceeded.

In an embodiment, the processing unit is configured to detect at least one of Rayleigh, Brillouin and Raman scattering in order to assess variations in strain or strain rate.

In an embodiment, the processing unit is further configured to map the time history of strain or strain rate data along the length of the cable to provide visible indicia of the condition of the cable.

In an embodiment, the system further includes mapping the location of natural and/or manmade risks or hazards in the vicinity of the cable.

In an embodiment, determining the dynamic strain rate at adjoining locations along the length of the fibre to obtain dynamic strain rate data includes converting raw data from the backscattered signals to strain-rate equivalent units with the following formula: ε(x,t)=λ/4πngξ dφ(t), where λ is the optical wavelength, n is refractive index, g is the gauge length, defined as the distance between two points of the fibre where the measurement is taken, and ξ=0.7869.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is an exemplary illustration of a typical double armored subsea fibre-optic cable.

FIG. 2A illustrates an example of a system for distributed acoustic sensing.

FIG. 2B illustrates an example of the electrical signal generated by the system of FIG. 2A over time.

FIG. 3 is a schematic diagram of a disclosed method of distributed acoustic sensing to detect dynamic strain rate according to some aspects of the present disclosure.

FIG. 4A illustrates schematically a transmission sequence of interrogating optical signals at multiple instants and a sequence of corresponding observation windows.

FIG. 4B illustrates schematically an example of amplitude vs distance plots provided by a system of the present disclosure.

FIG. 5 is a schematic diagram that shows the steps to process the data according to the disclosed method of distributed acoustic sensing of the present invention.

FIG. 6 is an exemplary cable strain map of a subsea fibre optic cable using Distributed Fibre Optic Sensing (DFOS) across a harbor in Wellington.

FIG. 7 is an exemplary cable strain map of a subsea fibre optic cable using DFOS across Wellington harbor.

FIGS. 8A-B are exemplary strain data plots in a single channel over time of a submarine fibre optic cable using DFOS.

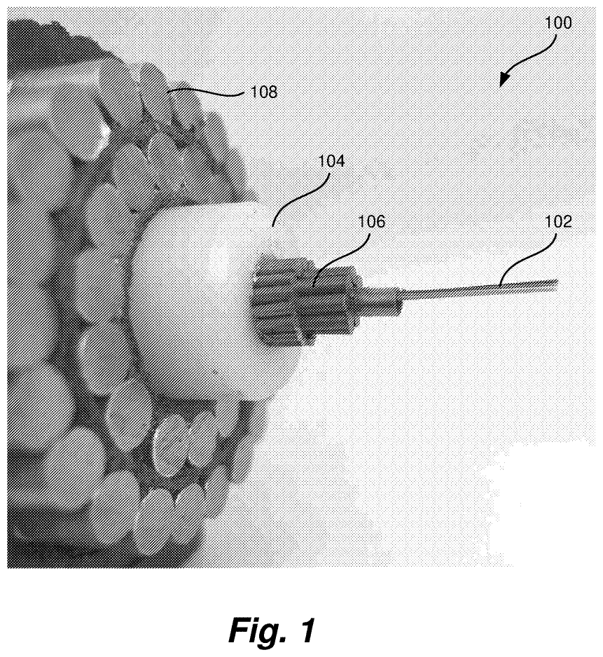

### DETAILED DESCRIPTION

Commercial submarine cables may commonly be designed with single armor layer of steel to provide strain tolerance. For example, a cable of 31 mm in total (outer) diameter, and having a fibre and cable breaking load of 396 kN, would be no stronger than a steel wire being of the same diameter and strength, which is equivalent to a maximum strain limit of 2 millistrain.

It may be desirable to monitor the condition of a cable, especially in the precursory period before failure, especially in areas where there is a higher chance of external hazards (e.g., high seismic or artificial risk areas). Up to date information on the condition of the cable may allow it to be replaced or repaired before it fails.

There are two common techniques currently utilized to assess and monitor the health of an installed submarine cable. In one technique, a campaign-style survey of the cable asset is conducted periodically. This might involve scuba divers, or remotely operated vehicles visually surveying the cable route for cable exposure points or damage. As can be appreciated, this method is expensive and sporadic. Furthermore, a cable may accumulate tension/be damaged in the period between two surveys and this may only be discovered in the next survey. Often such damage is not visible and therefore not readily ascertainable.

In another technique, multi-beam sonar or airborne LIDAR systems are used to map the seafloor or land and the cable assets. Multi-beam sonar surveys typically use a source-receiver array mounted directly on the ship's hull, while LIDAR systems use a laser scanner mounted on a helicopter. These methods of surveying the cable asset are extremely capital-intensive and time-consuming. Furthermore, logistically, these types of surveys cannot be conducted routinely or even annually to provide the data required to alert the cable assets owner and operators on the condition of the cable. In addition, such surveys cannot effectively be used to monitor cable state or state change due to cable strain unless this is visible, which is often not the case.

Accordingly, currently, there is no way to obtain data about the accumulated tension and/or compression that a cable is subjected to over time. Neither is there any accurate method of determining the state of stress experienced by a cable and its effect on the accumulated strain of the fibre over time. An in situ time history of the strain experienced by fibre optic cables may be useful in order to provide critical and novel data about the cable's performance against its design specification, as well as to monitor its performance and condition over time and allow impending cable failure/remaining anticipated lifespan to be detected or predicted.

Aspects of the present invention arise from a realization of the inventors that Distributed Fibre Optic Sensing (DFOS) data can be used to monitor cables in order to provide a time history of the strain accumulated by the cables. In other words, the method (and associated system) disclosed in aspects of the present disclosure measures the accumulation of tension and compression in a cable by measuring the dynamic strain rate on a per channel basis in an optical fibre associated with the cable. In particular, the disclosed systems and methods use DFOS over existing fibre optic cables that are embedded inside telecommunication or power cables, or bundled in a nearby but separate power cable to estimate the accumulated tension in the cable via measuring the dynamic strain rate along the length of the fibre optic cables. In some embodiments, the methods and/or systems use Rayleigh and/or Brillouin scattering in an optical fibre to assess the strain along the optical fibre. In particular, aspects of the present invention use DFOS to detect Rayleigh and/or Brillouin and/or Raman scattering in order to assess dynamic strain rate over short segments or gauge lengths. It is presumed that cables that experience dangerous environmental phenomena (e.g., earthquakes, rock fall, storms, tsunamis, and the like) or other types of external hazards accumulate tension over time, causing permanent strain to the cable. These differences or variations in strain may be utilized by the presently disclosed systems and methods to determine whether portions of a cable are degraded or permanently damaged and also determining the exact location of such damaged points.

The strain rate is defined as the change in strain (e.g. deformation due to accumulation of tension and compression) of the optical fibre with respect to time. In the present disclosure, the optical fibre acts as a series of independent linear strain (strain-rate) sensors. In other words, the strain increases linearly with increasing stress (e.g., due to an environmental hazard such as an earthquake).

In one example, DFOS data is recorded from the shore side of a single mode optical fibre that has been incorporated into a submarine cable wet plant or that is separated but located near a submarine cable asset. In another example, DFOS data is recorded from a pre-installed fibre optic cable that is part of an installed fibre optic communication network or separated from the network. DFOS data is collected and used to estimate dynamic strain rate. In particular, the strain history measured per channel can be used to monitor particular potential failure points in a cable over months to years, or to capture the total impact of a particular single event such as a large magnitude earthquake or a near-miss cable strike. The maximum spatial resolution for this technique is around 10 meters.

Next, a determination is made whether any portions of the monitored cable are likely degraded or damaged based on the DFOS data (and comparing the DFOS data with the design specification of the cable). Then, if a determination is made that one or more portions of the monitored cable are likely degraded or damaged, a cable strain map is generated. The cable strain map may indicate the actual geographical locations of potential areas of the fibre under permanent or regular strain and a risk level associated with the exposure. In some embodiments, the cable strain map may include contextual information, such as the depth of the water above the likely cable exposure point, the frequency of marine vessel paths crossing over the likely cable exposure point, the frequency of high risk AIS navigation status alerts, storm and high wave activity forecasts, history of cable strike in the region, and/or cable owner risk tolerance. Finally, based on the cable strain map, a warning may be issued to the cable owner or cable operator or a cable infrastructure user for consideration of mitigation strategies—such as preventative maintenance, substituting the cable or part thereof, measuring the effect of a particular repair event, or avoiding the site of the potential damage. Optionally, an alert may be automatically communicated, e.g., through an automatic identification system (AIS) to alert potential marine vessels in the region about any locations that may have damaged cables.

The system and method of the present invention can thus lead to better design engineering of subsea cables, as well as retrofitting behaviors in which cable sections are replaced when and where they begin to show signs of exceedance fatigue, thereby avoiding the often catastrophic consequences of failure.

These and other aspects of the present disclosure will be described in detail in the following sections.

### Example DFOS System

Generally speaking, a DFOS system includes an interrogation unit and a sensing cable. The interrogation unit continuously injects short pulses of optical signals into the sensing cable. When light passes through the fibre cores of the sensing cable, the incident light is scattered in different directions due to spatial variations in the refractive index of the fibre cores and different kinds of backscattered light (such as Rayleigh, Raman and Brillouin) are generated. When the optical fibres are disturbed and subjected to strain and/or vibrations, the properties of the scattered light change (wavelength, light intensity, frequency, phase etc.). By analyzing certain characteristics of the returned scattered light, changes in various physical parameters (e.g., axial strain, strain rate, vibration dampening) can be revealed. Further, phase information of Rayleigh scattered light can be analyzed to obtain dynamic strain rate measurements.

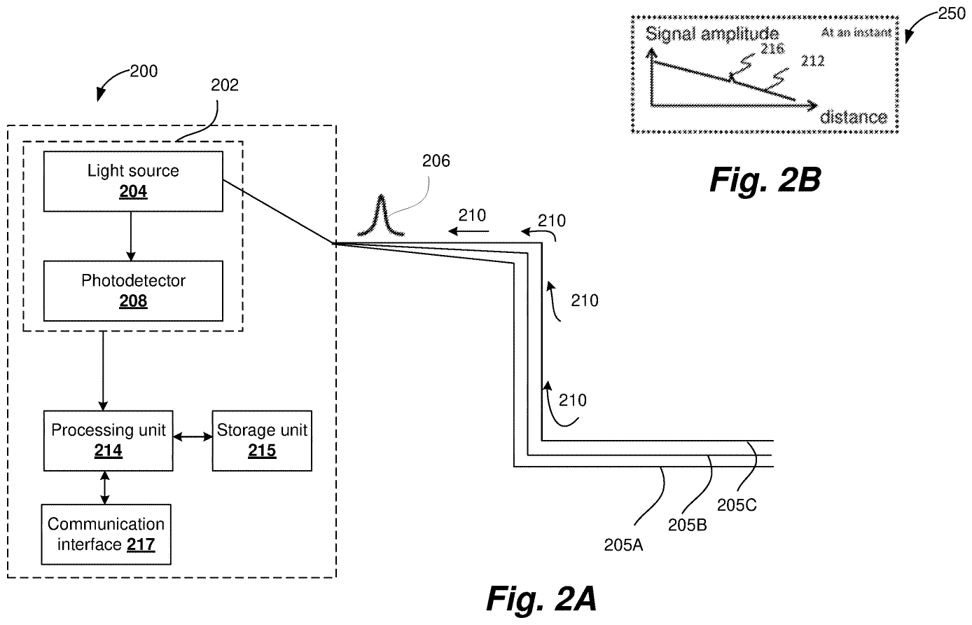

In one example, a system 200 for use in distributed fibre optic sensing (DFOS) is illustrated in FIG. 2A. The DFOS system 200 includes a coherent optical time-domain reflectometer (C-OTDR) 202. The C-OTDR 202 includes a light source 204 to emit an optical interrogation signal 207 in the form of a short optical pulse to be sent into one or more of optical fibres 205A, 205B, and 205C. Otherwise an existing fibre-optic submarine communications cable is utilized for DFOS sensing. The fibre can be laid in any orientation, or even wrapped around a central cylinder in a helical fashion to introduce more than one component of motion/deformation to each gauge length of the subsequent DFOS measurement. Further still, existing optical fibre laid for a different purpose can be utilized for the DFOS measurement. Multiple fibres can be joined in series and used for DFOS with one instrument, or multiple DFOS channels (analyzed with the same or separate DFOS instruments) can be used to record DFOS data within the same vicinity.

The light source 204 is a laser source. The laser source can be used with or without an external cavity. The optical interrogation signal 206 can be a simple pulse, chirped pulse, or continuous wave. Additionally, the optical interrogation signal 206 can be in the infrared or near infrared frequency range. In one embodiment the signal is a pulsed laser light having a wavelength of 1550 nm in the C-band suited to Rayleigh backscattering.

The C-OTDR 202 includes a photodetector 208 configured to detect the backscattered light 210 that is backscattered due to Rayleigh, scattering or Brillouin or Raman transitions from the incident wavelength by one or more of the optical fibres 205A, 205B and 205C. Rayleigh scattering is a form of an elastic scattering of light that conserves the kinetic energy of the incidental particles of the optical fibre in which the scattering takes place—that is, in this type of scattering the scattered photons have the same energy as the incident photons. Generally, Rayleigh scattering occurs in an optical fibre because of density heterogeneities that are frozen at manufacturing. Raman scattering is a form of inelastic scattering of light that does not conserve the kinetic energy of the incidental particles. Brillouin scattering is a “photon-phonon” interaction as annihilation of an incidental photon creates a Stokes photon and a phonon simultaneously. Both Raman and Brillouin scattering produce components called Stokes and Anti-Stokes components.

The returning light 210 is backscattered in a distributed manner in the optical fibre 205. In some embodiments, the photodetector 208 passes the detected optical signals 210 to the processing unit 214 directly. In other embodiments, the photodetector 208 may convert the optical signals 210 into electrical signals such that an amplitude of the electrical signal 212 is proportional to the reflected optical intensity resolved over time. The time scale may be translated to a distance scale relative to the photodetector 208. FIG. 2B illustrates a schematic plot of the amplitude of an optical signal over distance at one particular instant.

Returning to FIG. 2A, the DAS system 200 also includes a processing unit 214, within or separate from the C-OTDR 202. The processing unit 214 may be configured to process the returned optical signals from the optical fibres and store the processed data as DFOS data. In some embodiments, the processing unit 214 may be an optical processor that analyses the received optical signal optically. In other embodiments, the processing unit 214 may be a digital processor that converts the electrical signal received from the photodetector 208 into digital DFOS data and then stores this data. As referred to herein, DFOS data includes data relating to the strain of an optical fibre for a particular time sample at all sensor positions along the fibre.

In certain embodiments, the processing unit 214 determines the dynamic strain rate field along the optical fibre using the DFOS data.

In certain examples, input pulses may be transmitted continuously in the optical fibre, DFOS data may be continuously updated, and the dynamic strain rate field may also be computed continuously from the DFOS data. In other examples, the input pulses may be transmitted periodically (e.g., every few hours or days) and the DFOS data may be updated at the same frequency. The dynamic strain rate field along the optic fibre may be computed at the same frequency or at a different frequency (e.g., every few days). In other embodiments, the strain values may be computed sporadically (e.g., in response to a known activity, e.g., a storm, an earthquake, a cyclone, etc.).

In addition to determining the strain values, the processing unit 214 may also be configured to determine whether any portions of the cable have been degraded or damaged (e.g. by comparing the strain data and the design specification) and may also determine the geographical location of such likely damage, and generate a cable strain map. The processing unit 214 may also be configured to automatically generate alerts based on the accumulated strain or strain rate.

The DFOS data or recording may be stored in a storage unit 215. The storage unit 215 may include volatile memory, such as random access memory (RAM) for the processing unit 214 to execute instructions, calculate, compute, or otherwise process data. The storage unit 215 may include non-volatile memory, such as a hard-disk drive for the processing unit 214 to store data before or after signal-processing and/or for later retrieval. The processing unit 214 and storage unit 215 and may be distributed across numerous physical units and may include remote storage, such as cloud storage, in which case the processing unit 214 and storage unit 215 may be more generally defined as a cloud computing service.

Finally, the system 200 also includes a communication interface 217 in communication with the processing unit 214 that may be utilized to communicate the cable strain map to cable operators and/or send alert signals to vessels in the vicinity of a likely cable strained/damaged location. The communication interface may also be configured to receive requests for cable strain maps from one or more remote mobile or fixed terminals 217A, 217B, and 217C. Upon receiving a request for a cable strain map, the processing unit 214 may be configured to generate or retrieve (if already generated and stored) the requested strain map from the storage unit 215.

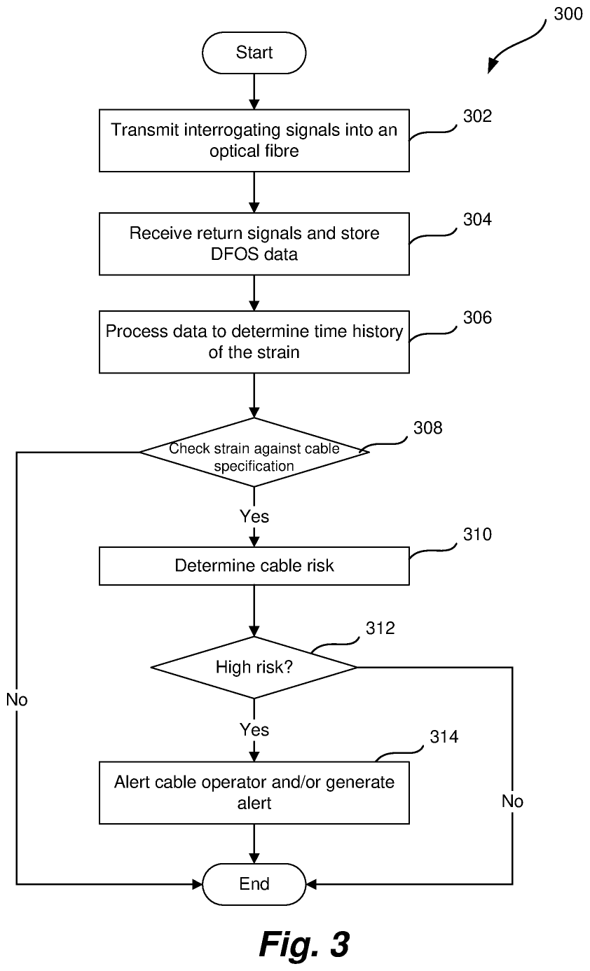

FIG. 3 is a flowchart illustrating an example method 300 for determining the dynamic strain rate of a cable according to some aspects of the present disclosure.

The method 300 commences at step 302, where interrogating optical signals 206 are transmitted by the light source 204 into the one or more optical fibres 205 that are integrated with the one or more cable assets. The optical fibre may for example the single mode fibre used in a typical submarine cable. Such a fibre is generally designed and manufactured to be ITU G.654 compliant, which is a single-mode fibre with a zero-dispersion wavelength around 1300 nm, cut-off shifted and loss minimized around 1550 nm, and optimized for use in the 1500-1600 nm wavelength range. G.654 fibers for submarine applications typically offer an improved attenuation specification in the range of 0.15 db/km-0.17 db/km.

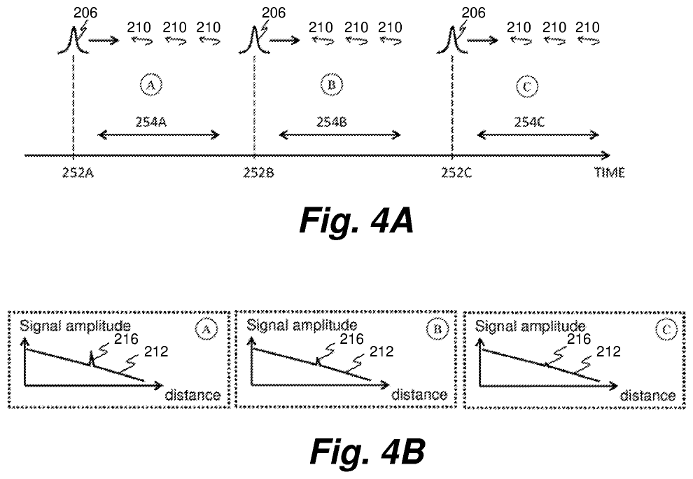

The interrogating signals may be transmitted at multiple instances. FIG. 4A illustrates example interrogating optical pulses transmitted by the light source at this step. In particular, FIG. 4A shows three time instants 252A, 252B, and 252C at which interrogating optical signals 206 are transmitted in the optical fibre.

Once the signals are transmitted, the method proceeds to step 304, where backscattered signals 210 are received from the one or more optical fibres 205.

FIG. 4A also shows the return or backscattered signals. These return signals 210 are received in the observation periods 254A, 254B, and 254C between time instants 252A, 252B, and 252C. The time at which a return signal is received in the observation period indicates the location in the optical fibre from which the optical signal has been backscattered. The later a return signal is received in the observation period, the further away along the optical fibre the signal was backscattered from. Properties of the returned optical signal (e.g., wavelength, light intensity, frequency, phase, etc.) may change depending on the type of strain experienced by a section of the optical fibre. Accordingly, by analyzing the properties and the timing of the return signals, the processing unit can determine the strain experienced by particular portions of the optical fibre 205 at known locations along the fibre.

In particular, from the time of flight of the returning signal 210 (due to Rayleigh, Brillouin or Raman scattering), a fibre channel position can be inferred using the known optical fibre refractive index n, asz=ct/2n. For example, a standard single-mode fibre (attenuation=0.15 dB/km at 1550 nm) has ~1,000 potential Rayleigh scattering sites/meter.

The backscattered signal 210 for a fibre channel is mixed with a reference signal at the photodetector, forming an interferometric intensity signal:

$$I ( t ) = {\vert {E}_{1} \vert}^{2} + {\vert {E}_{2} \vert}^{2} + 2 \vert {E}_{1} \vert \vert {E}_{1} \vert {e}^{j ( 2 π d φ ( t ) + {φ}_{1} - {φ}_{2} )}$$

Where E1 and E2 are the field magnitude terms, φ₁ and φ₂ are the field phase terms, and dφ is the phase delay measured in radians.

It will be understood that different options exist for the choice of the reference signal, including a second pulse delayed by a known time, a Michelson or Mach Zehnder reference signal, or a heterodyne local oscillator.

FIG. 4B shows the return optical signals 210 of FIG. 4A converted into electrical signals 212 by the photodetector 208. Each electrical signal 212 has a fluctuation peak 216. The different fluctuation peaks 216 shown in FIG. 4B are due to the different returning optical signals 210 that are generated due to different types of strain experienced by a section or sections of the optical fibre.

The electrical signals or the optical signals received from the optical fibres 205 are digitized and converted into DFOS data and this data may be stored by the processing unit 214 in the storage unit 215 at this step. The storage unit 215 contain values about the state of the optical fibre for a particular time sample at all sensor positions in the fibre. It will be appreciated that steps 302 and 304 may be continuously repeated, periodically repeated, or performed at some other frequency. In other cases, these steps may be performed based on one or more trigger conditions—e.g., in response to a request for a cable strain map, one or more activities (e.g., storms, earthquakes etc.) being detected in the vicinity of the cable.

It will be appreciated that the frequency band of the DFOS data is 0.001-500 Hz, thus including a broad frequency range, from static or near-static timescales up to the Nyquist sampling frequency of the technique disclosed herein. For Rayleigh scattering methods such as DFOS, the Nyquist frequency can be 1000 Hz for subsea cable spans of 50 km long. Thus, the DFOS measurement bandwidth covers multiple available environmental phenomena or signals created by an active source in the environment.

For example, DFOS techniques are capable of detecting disturbances having a wide range of frequencies. This may be include, e.g., ocean noise (acoustic waves traveling in the water column), Scholte waves (interfacial waves traveling between the water column and the seafloor), ocean loading (coupling of the ocean surface gravity waves) or earthquake seismic waves (elastic waves moving through the solid earth). The DFOS techniques described herein can also detect passing marine vessels by altering the frequency of the input pulses such that they are in the range of the frequency of marine vessels based on their dimensions and velocity.

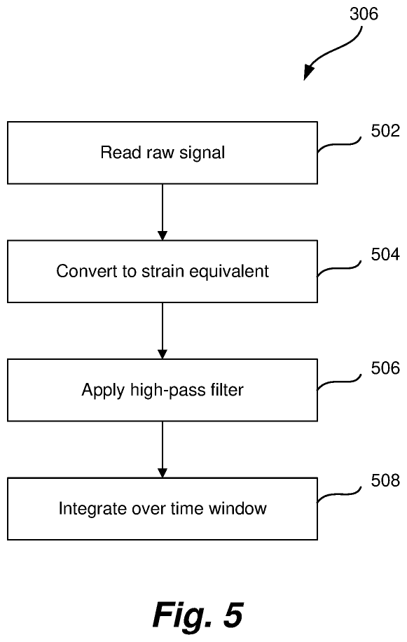

At step 306, the collected DFOS raw data are processed in the processing unit 214 to extract the time history of the strain experienced in situ by the optical fibre. The sub-steps to process the DFOS data are shown in FIG. 5 and discussed below.

Turning to FIG. 5, the method commences at step 502, where the DFOS raw data are read out by the processor 214 and converted to strain-rate equivalent units (at step 504). In one example, the following formula may be utilized for this conversion:

$$ε ( x , t ) = \frac{λ}{4 π ng ζ} d φ ( t ) \qquad ( 2 )$$

where λ is the optical wavelength, n is refractive index, g is the gauge length, defined as the distance between two points of the fibre where the measurement is taken, and ξ=0.7869.

This parameter is measured between successive pulses in the same channel or between successive channels for the same pulse. The choice of photonic implementation determines if the raw DAS dataset has units equivalent to dynamic strain rate by the formula above.

Alternatively, the conversion step 504 could be performed by measuring the strain rate from the strain data using the native sampling rate as the time constant of differentiation followed by conversion to strain units using the formula (2).

It will be understood that, if refractive index and temperature are assumed to be constant or varying in a bounded range, then the above formula allows to measure the axial strains (ε=dL/L). This is because, under these assumptions, there is no optical phase change recorded and therefore the strain is in a linear relationship with the gauge length.

Furthermore, it is important to note that the measurement of the strain rate can be affected by the optical phase noise that increases periodically due to laser frequency noise and self-homodyne and self-heterodyne interferometry over long range. As a result optical noise presents a large noise floor contribution for DFOS measurements at low frequencies of f<10 Hz. However, DFOS phase measurement can be stabilized against this noise source by an external-cavity or similar device that provides a reference path to directly eliminate the optical noise.

At step 506, a high pass filter is applied to remove any laser noise in the case where the external cavity is not used.

At step 508, an integration operator is applied over a time window of a predefined size (t2−t1). In one example, the following formula may be utilized:

$$P ( x , t ) = {\int }_{t 1}^{t 2} ε ( x , t ) dt \qquad ( 3 )$$

The integration over time allows the changes in strain experienced by the fibre before and after an event has occurred to be calculated (e.g. an earthquake). This is the dynamic strain rate that takes into account the accumulation of strain (thus the history of the strain) that the fibre has experienced.

After the integration step 508, the processing of the data terminates.

Turning back to FIG. 3, once the processing step (step 306) terminates, the time history of the (accumulated) strain experienced in situ by the optical fibre is monitored (step 308) in a distributed way, thus in multiple channels of the fibre. This dynamic strain rate measurement allows to understand of how a cable is performing mechanically in each channel against its design specification.

In step 310, if a particularly important event is identified (e.g., an earthquake, storm, tsunami) for example, through a thresholding of the change in dynamic strain rate from one sample to the next, the cable user or owner can alert a fishermen and/or maritime vessel operator or a terrestrial operator that an incident has been detected. For example, after an earthquake has occurred, the system 100 of the present invention allows measurement of the changes in strain experienced by the fibre before and after the earthquake. If the system 100 records a strain approaching or exceeding the design specification, an alert is generated. Alerts may be staged depending on the extent to which the specification is approached or exceeded.

At step 312 a determination is made whether the time history based on the accumulated strain rates recorded over time in each channel or section of the fibre have a strain score that is higher than a threshold score (e.g. in some embodiments the design specification is just below the threshold score, in other embodiments, the design specification equates to the threshold score or is say +5% above the threshold score). If none of the accumulated strains have a score that is higher than the threshold score, the method 300 ends. Alternatively, if even one of the strains has a score that exceeds the threshold score, the method proceeds to step 314 where the processing unit 214 may be configured to issue a warning or alert to the cable owner or cable operator or a cable infrastructure user for consideration of mitigation strategies. Optionally, the processing unit 214 may also communicate an alert through an AIS to alert potential marine vessels in the region about the likely locations of the section or channel of the fibre experiencing permanent strain (or high values of dynamic strain rate). In some examples, the alert may be communicated via the communication interface 217. The alert may include information regarding the geographic location of the cable exhibiting permanent strain and may alert fishing and trawling vessels to be careful in that area.

In an alternative embodiment, the measured strain rate itself may be compared against a threshold strain rate, and an alert may be generated even if the accumulated strain does not exceed the threshold. In a still further embodiment, both the accumulated strain and the strain rated may have thresholds which in combination trigger an alert.

In another embodiment, the processing unit 214 may provide the cable strain map to the cable operator and after receiving the cable strain map, the cable operator may flag the strain location with a live AIS beacon to alert potential marine vessels in the region so that fishermen and maritime vessel operators would know about the increased hazard. Alternatively, other devices can be implemented to flag the coordinates of the location of the section or channel of the fibre experiencing permanent strain, for example location coordinates can be transmitted via the Internet, via Emergency Position Indicating Radio Beacons (EPIRB) alerts or other quantitative information devices such as satellite devices (i.e. GPS location tracker).

In the method 300 described above, baseline measurements may be required to determine the location of the section or channel of the fibre experiencing permanent strain. To this end, when a cable is first laid an interrogation signals may be transmitted in the sensing optical fibre and return signals may be received and processed to determine the baseline strain of the optical cable (when deployed for the first time). Alternatively, the design specification from the manufacturer can be used as baseline strain data. The baseline strain may be compared with historical strain data accumulated by the optical cable to determine differences from the baseline and identify potential points of where the fibre is exhibiting permanent tension. For example, if the strain of the signals has increased in a particular location over an extended period of time from the baseline levels, the processing system may determine that location to be a likely point of permanent damage or degradation of the fibre.

The baseline readings may also be utilized to identify inherent zones of low or high strain (e.g., terrestrial zones or surf zones) which can be used later to label the statistical plots and mask those zones.

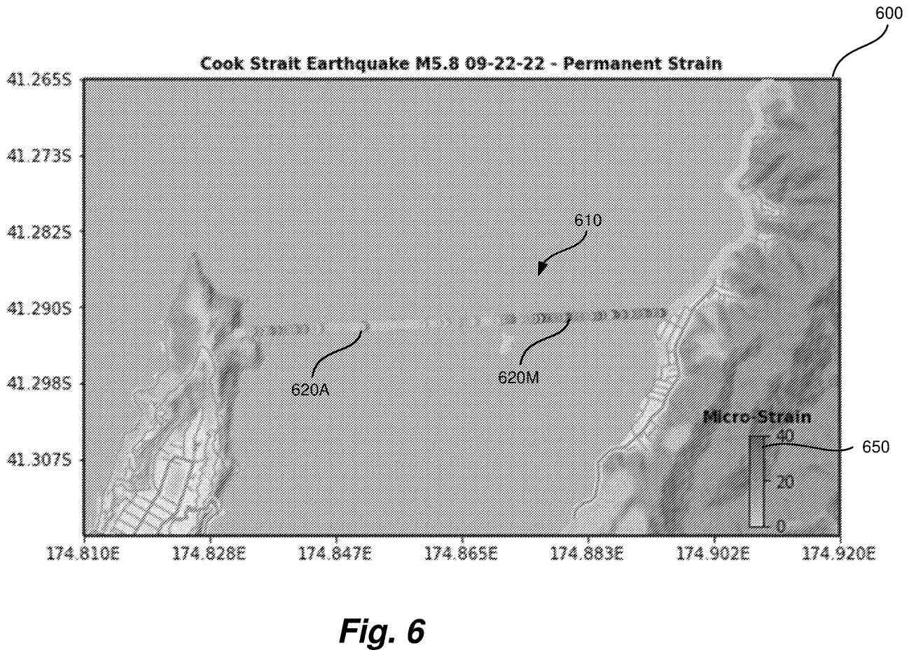

FIG. 6 shows a map view 600 of strain data from a subsea fibre optical cable 610 recorded with the system 200 recording across Wellington harbor, New Zealand. This method was recently demonstrated for a single large magnitude earthquake using a submarine cable segment offshore the North Island of New Zealand.

Each circle in FIG. 6 represents one channel (e.g. channels 620A, 620 M) of the fibre array during one day when a significant strain event occurred (in this case an earthquake), showing how the subsea cable has deformed through time. The color of the circles (representing the channels, for example 620A, 620M) on a grayscale represents the dynamic strain rate output of the applying the proposed methodology. From the scale bar 650, it is possible to see that the strain was upwards of 40 micro-strain in amplitude at some channels but negligible at other locations. The cable shows variations at the scale of 100 m. The full shore to shore length of the cable is about 5 km.

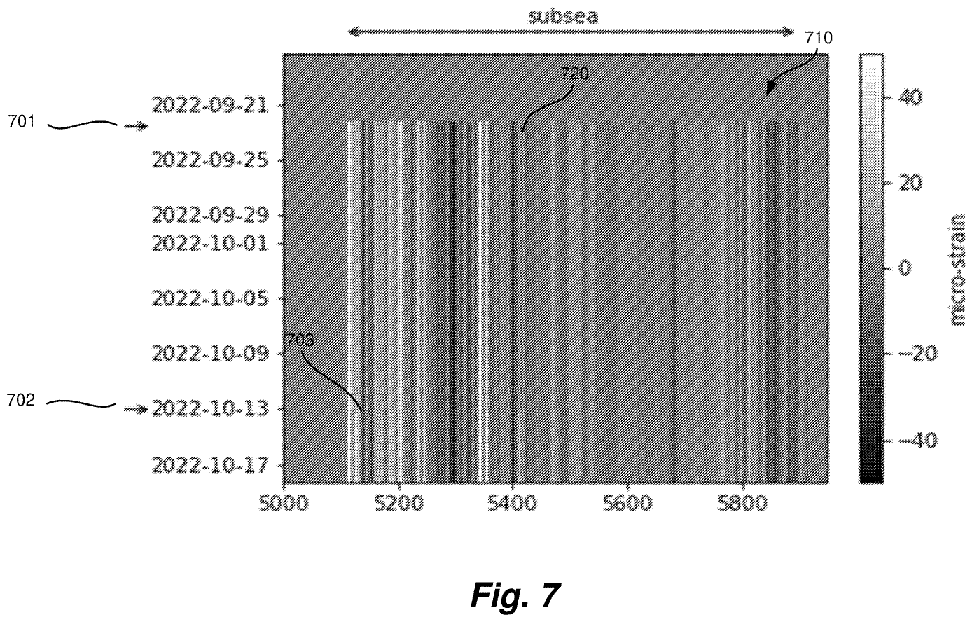

FIG. 7 is an exemplary plot of results from the subsea fibre optic DFOS recording across Wellington harbor, New Zealand shown in FIG. 6. The time axis 701 on the left shows how the channels of the fibre optic cable deform all at once. In particular, FIG. 7 shows that microstrains in the cable are recorded for the first time at 701 (corresponding to date 2022 Sep. 23), first arrow is first earthquake). These channel-by-channel time histories show added deformation at the time of a second significant event 702 (corresponding to date 2022 Oct. 13 second arrow is an aftershock). This is shown more clearly at 703 showing changes in strain. The numbers 5000-5800 are channels index (720) along the optical fibre cable 710 with a channel spacing of 6.38 m.

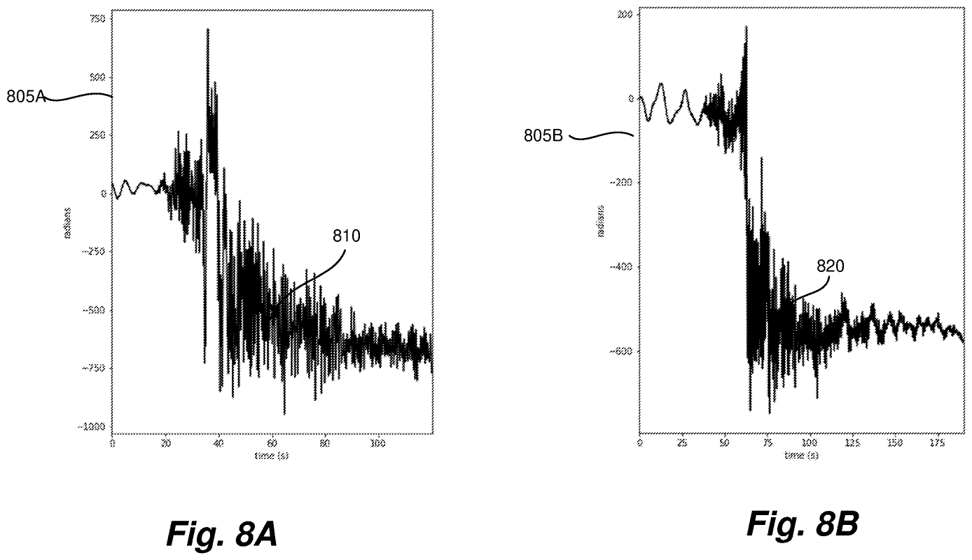

FIGS. 8A-B shows exemplary single channel time histories during major strain accumulation. As can be seen, the strain is punctuated. In FIG. 8A the strain during M5.8 earthquake shows that this section 810 of the cable went into compression (negative strain). The amplitudes 805A and 805B is shown in optical radians units or strain equivalent. In FIG. 8B the strain during a subsequent large aftershock (M5.7) shows that this section of the cable went into compression 820 by an amount that is approximately 80% of the permanent strain from the main shock.

Mapping the cable strain risk as described herein has several advantages. A key advantage is that, after the identification of the permanent strain in a section of the fibre (as shown in FIGS. 6, 7), the cable operator can flag this location to prevent or minimize aggression hazards to the cable there.

Further, in the system and method described above, data can alternatively be recorded with telecommunication receiver statistics themselves for DFOS, without a dedicated instrument at one end, to extract information related to the fibre state, such as a property of polarization or time of flight from one end to the other which might carry information about the time-rate of change of fibre length, or state of stress or strain of the fibre at a point or over its length.

It will be understood that the invention disclosed and defined in this specification extends to all alternative combinations of two or more of the individual features mentioned or evident from the text or drawings. All of these different combinations constitute various alternative aspects of the invention.

As used herein, except where the context requires otherwise, the term “comprise” and variations of the term, such as “comprising”, “comprises” and “comprised”, are not intended to exclude further additives, components, integers or steps.

1. A method for determining a condition of a cable, the method comprising:
transmitting interrogating signals into a sensing optical fibre extending a length of the cable;
receiving backscattered signals from the sensing optical fibre in response to the interrogating signals;
processing the backscattered signals to determine variations in strain or strain rate along the sensing optical fibre; and
determining a time history of the strain or strain rate to obtain accumulated strain data indicative of the condition of the cable at points along the cable.

2. The method of claim 1 wherein the cable is: a submarine fibre optic cable having at least one primary fibre optic telecommunications or a sensing cable which doubles as the sensing optical fibre.

3. The method of claim 1, wherein the cable is a power cable and the sensing optical fibre is embedded inside the power cable or bundled in a nearby but separate cable.

4. The method of claim 1, wherein processing the backscattered signals includes determining a dynamic strain rate at adjoining locations along the length of the fibre to obtain dynamic strain rate data, and determining the time history of the strain rate include integrating the dynamic strain rate data over a predetermined period of time.

5. The method of claim 1, further comprising comparing the accumulated strain data against a threshold based on cable specification data and generating an alert condition in an event of the threshold being exceeded at at least one location along the cable.

6. The method according to claim 5, further comprising determining cable risk, and generating an alert condition in the event of a high risk being identified and the threshold being exceeded.

7. The method according to claim 6 wherein the risk is based on natural and/or man-made risks or hazards in the vicinity of the at least one location.

8. The method according to claim 1, wherein DFOS is used to detect at least one of Rayleigh, Brillouin, and Raman scattering in order to assess variations in strain or strain rate.

9. The method according to claim 1, further comprising mapping the time history of strain or strain rate data along the length of the cable to provide visible indicia of the condition of the cable.

10. The method according to claim 9, further comprising mapping a location of natural and/or man made risks or hazards in the vicinity of the cable.

11. The method according to claim 4 wherein determining the dynamic strain rate at the adjoining locations along the length of the fibre to obtain dynamic strain rate data includes converting raw data from the backscattered signals to strain-rate equivalent units with the following formula:
$$ε ( x , t ) = λ / 4 π ng ξ d φ ( t )$$
where λ is an optical wavelength, n is a refractive index, g is a gauge length, defined as a distance between two points of the fibre where a measurement is taken, and ξ=0.7869.

12. A distributed fiber optic sensing (DFOS) system for determining a condition of a cable, the system comprising:
a light source for transmitting interrogating signals into a sensing optical fibre extending a length of the cable;
a photodetector for receiving backscattered signals from the sensing optical fibre in response to the interrogating signals;
a processing unit configured to:
process the backscattered signals to determine variations in strain or strain rate along the sensing optical fibre; and
determine a time history of the strain or strain rate to obtain accumulated strain data indicative of the condition of the cable at points along the cable.

13. The system of claim 12 wherein the cable is: a submarine telecommunication or power cable and the sensing optical fibre is embedded in the cable or bundled in a nearby but separate cable.

14. The system of claim 12, wherein:
to process the backscattered signals, the processing unit is further configured to determine a dynamic strain rate at adjoining locations along the length of the fibre to obtain dynamic strain rate data, and
to determine the time history of the strain rate, the processing unit is configured to integrate the dynamic strain rate data over a predetermined period of time.

15. The system of claim 12, wherein the processing unit is further configured to:
compare the accumulated strain data against a threshold based on cable specification data; and
generate an alert condition in an event of the threshold being exceeded at at least one location along the cable.

16. The system according to claim 15, wherein the processing unit is further configured to:
determine cable risk, and
generate an alert condition in the event of a high risk being identified and the threshold being exceeded.

17. The system of claim 12, wherein the processing unit is configured to detect at least one of Rayleigh, Brillouin and Raman scattering in order to assess variations in strain or strain rate.

18. The system of claim 12, wherein the processing unit is further configured to map the time history of strain or strain rate data along the length of the cable to provide visible indicia of the condition of the cable.

19. The system according to claim 18, wherein the processing unit is further configured to map a location of natural and/or manmade risks or hazards in the vicinity of the cable.

20. The system according to claim 14, wherein determining the dynamic strain rate at adjoining locations along the length of the fibre to obtain dynamic strain rate data includes converting raw data from the backscattered signals to strain-rate equivalent units with the following formula:
$$ε ( x , t ) = λ / 4 π ng ξ d φ ( t )$$
where λ is an optical wavelength, n is a refractive index, g is a gauge length, defined as a distance between two points of the fibre where a measurement is taken, and ξ=0.7869.
